(19) United States
(12) Patent Application Publication
(10) Pub. No.: US 2025/0348027 A1
(43) Pub. Date: Nov. 13, 2025

(54) FIXING UNIT

(71) Applicant: CANON KABUSHIKI KAISHA, Tokyo (JP)

(72) Inventors: TATSUO YASUI, Tokyo (JP); KENICHI TANAKA, Ibaraki (JP); TAKUYA HASEGAWA, Tokyo (JP); RIKIYA TAKEMASA, Chiba (JP); TOMOYUKI KURIYAMA, Tokyo (JP); TAKESHI KOZUMA, Ibaraki (JP); MASAKI FURUTANI, Chiba (JP)

(21) Appl. No.: 19/194,700

(22) Filed: Apr. 30, 2025

(30) Foreign Application Priority Data
May 8, 2024 (JP) 2024-076022

(51) Int. Cl. G03G 15/20

(52) U.S. Cl. CPC G03G 15/2028; G03G 15/2032; G03G 15/2064; G03G 2215/2025

(57) ABSTRACT

A fixing unit includes a first separation member, a second separation member, a conveyance unit, and a second frame. The second frame pivots between a first position and a second position. The first position is a position where the first separation member is at a first separation position, the second separation member is at a second separation position, and the conveyance unit is at a conveyance position. The second position is a position where the first separation member is at a first retracted position, the second separation member is at a second retracted position, and the conveyance unit is at a conveyance retracted position. A distance between the first separation member and the second separation member when the second frame is at the second position is shorter than a distance between the first separation member and the second separation member when the second frame is at the first position.

### BACKGROUND OF THE INVENTION

### Field of the Invention

This disclosure relates to a fixing unit suitable for use in an image forming apparatus, such as a printer, a copier, a facsimile, or a multifunction machine, that uses electrophotographic technology.

### Description of the Related Art

Hitherto, in image forming apparatuses, toner images are formed by developing electrostatic latent images formed on photosensitive drums using toner, and, after being transferred onto recording materials, these toner images are fixed on recording materials in fixing units. The fixing units, for example, include heating rotary members, such as fixing belts, and pressing rotary members, such as pressing rollers, and unfixed toner images are fixed on the recording materials by applying heat and pressure to the recording materials in fixing nip portions formed between the heating and pressing rotary members. In addition, in Japanese Patent Laid-Open No. 2014-202851, it is known that a contact-type or non-contact type separation member is provided in the fixing unit to separate the recording material adhered to the heating and pressing rotary members after the recording material passes through the fixing nip portion. The separation member is positioned with respect to the heating and pressing rotary members to ensure the separation of the recording material.

### SUMMARY OF THE INVENTION

According to a first aspect of the present invention, a fixing unit configured to fix a toner image on a recording material includes a first rotary member, a second rotary member configured to come into contact with the first rotary member to form a nip portion with the first rotary member, the nip portion being configured to fix the toner image on the recording material by applying heat and pressure to the recording material, on which the toner image has been formed, while nipping and conveying the recording material, a first frame configured to hold the first rotary member and the second rotary member, a first separation member configured to separate the recording material from the first rotary member, the recording material having passed through the nip portion, a second separation member configured to separate the recording material from the second rotary member, the recording material having passed through the nip portion, a conveyance unit arranged downstream of the nip portion, the first separation member, and the second separation member in a conveyance direction of the recording material and configured to convey the recording material having passed through the nip portion, a second frame holding the first separation member, the second separation member, and the conveyance unit, and configured to pivot with respect to the first frame, and a supporting portion supporting the second separation member rotatably with respect to the second frame. The second frame is configured to pivot between a first position and a second position. The first position is a position at which the first separation member is positioned at a first separation position at which the first separation member separates the recording material from the first rotary member, the second separation member is positioned at a second separation position at which the second separation member separates the recording material from the second rotary member, and the conveyance unit is positioned at a conveyance position at which the conveyance unit conveys the recording material having passed through the nip portion. The second position is a position at which the first separation member is positioned at a first retracted position at which the first separation member is more retracted from the first rotary member than the first separation member at the first separation position is, the second separation member is positioned at a second retracted position at which the second separation member is more retracted from the second rotary member than the second separation member at the second separation position is, and the conveyance unit is positioned at a conveyance retracted position at which the conveyance unit is more retracted from the nip portion than the conveyance unit at the conveyance position is. A distance between the first separation member and the second separation member in a case where the second frame is positioned at the second position is shorter than a distance between the first separation member and the second separation member in a case where the second frame is positioned at the first position.

According to a second aspect of the present invention, a fixing unit configured to fix a toner image on a recording material includes a first rotary member, a second rotary member configured to come into contact with the first rotary member to form a nip portion with the first rotary member, the nip portion being configured to fix the toner image on the recording material by applying heat and pressure to the recording material, on which the toner image has been formed, while nipping and conveying the recording material, a first frame configured to hold the first rotary member and the second rotary member, a first separation member configured to separate the recording material from the first rotary member, the recording material having passed through the nip portion, a second separation member configured to separate the recording material from the second rotary member, the recording material having passed through the nip portion, a conveyance unit arranged downstream of the nip portion, the first separation member, and the second separation member in a conveyance direction of the recording material and configured to convey the recording material having passed through the nip portion, a second frame holding the first separation member, the second separation member, and the conveyance unit, and configured to pivot with respect to the first frame, and a supporting portion supporting the second separation member rotatably with respect to the second frame. The second frame is configured to pivot between a first position and a second position. The first position is a position at which the first separation member is positioned at a first separation position at which the first separation member separates the recording material from the first rotary member, the second separation member is positioned at a second separation position at which the second separation member separates the recording material from the second rotary member, and the conveyance unit is positioned at a conveyance position at which the conveyance unit conveys the recording material having passed through the nip portion. The second position is a position at which the first separation member is positioned at a first retracted position at which the first separation member is more retracted from the first rotary member than the first separation member at the first separation position is, the second separation member is positioned at a second retracted position at which the second separation member is more retracted from the second rotary member than the second separation member at the second separation position is, and the conveyance unit is positioned at a conveyance retracted position at which the conveyance unit is more retracted from the nip portion than the conveyance unit at the conveyance position is. The second separation member is configured not to come into contact with the first separation member in a case where the second frame is positioned at the first position. The second separation member is configured to come into contact with the first separation member in a case where the second frame is positioned at the second position.

Further features of the present invention will become apparent from the following description of exemplary embodiments with reference to the attached drawings.

### BRIEF DESCRIPTION OF THE DRAWINGS

FIG. 1 is a schematic diagram illustrating an image forming apparatus suitable for using a fixing unit of this embodiment.

FIG. 2 is a schematic diagram illustrating the fixing unit of this embodiment.

FIG. 3 is a perspective view illustrating a sheet discharge unit.

FIG. 4 is a diagram for explaining a separation claw.

FIG. 5 is a schematic diagram illustrating the separation claw of this embodiment in a state in which the sheet discharge unit is opened.

FIG. 6A is a diagram illustrating the separation claw of this embodiment.

FIG. 6B is a diagram illustrating a separation claw of a comparative example.

FIG. 7 is a schematic diagram illustrating the separation claw of the comparative example in a state in which the sheet discharge unit is opened.

### DESCRIPTION OF THE EMBODIMENTS

### Image Forming Apparatus

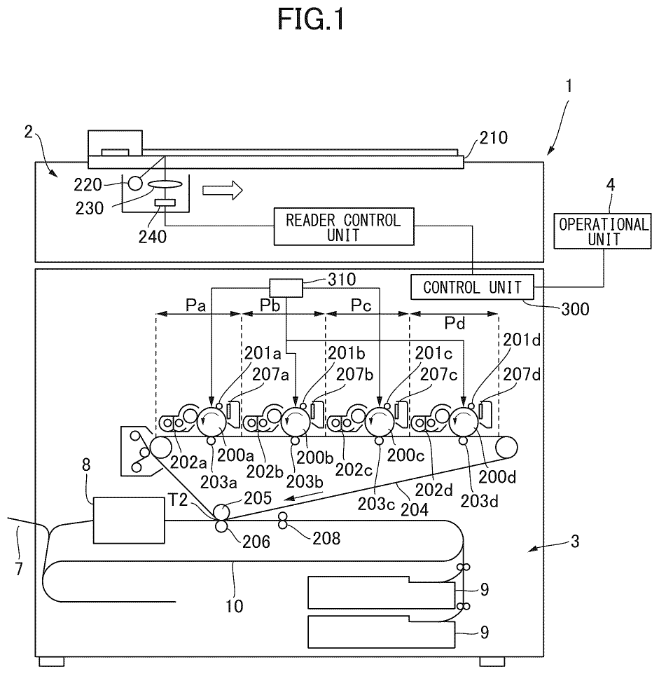

This embodiment will be described. First, using FIG. 1, a schematic configuration of an image forming apparatus suitable for using a fixing unit of this embodiment will be described. The image forming apparatus 1 is a full color printer of an electrophotographic system, which includes four image forming units Pa, Pb, Pc, and Pd that correspond to four colors: yellow, magenta, cyan, and black. The image forming apparatus 1 of this embodiment is a tandem type system in which the image forming units Pa, Pb, Pc, and Pd are arranged along a rotational direction of an intermediate transfer belt 204. The image forming apparatus 1 forms a toner image on a recording material based on an image signal from a document reading apparatus 2 connected to an apparatus body 3 (casing) of the image forming apparatus 1 or an external host device such as a print server communicatively connected to the apparatus body 3. The recording material includes a sheet material such as a paper sheet, a plastic film, and cloth.

As illustrated in FIG. 1, the image forming apparatus 1 includes the document reading apparatus 2 and the apparatus body 3. The document reading apparatus 2 is configured to read a document placed on a platen glass 210. Light emitted from a light source 220 reflets off the document and is focused onto a charge coupled device (CCD) sensor 240 via an optical member 230 such as a lens. This type of the optical unit reads a document line by line and converts it into an electrical signal data sequence when scanned in an arrow direction in FIG. 1 under the control of a reader control unit. The image signal obtained by the CCD sensor 240 is sent to a control unit 300, and the control unit 300 performs image processing according to each of the image forming units Pa, Pb, Pc, and Pd. In addition, as the image signal, the control unit 300 also receives an external input from the external host device such as the print server. The control unit 300 controls the overall operation of the image forming apparatus 1.

The apparatus body 3 includes the plurality of image forming units Pa, Pb, Pc, and Pd, and image formation is performed in each of the image forming units Pa to Pd based on the image signal described above. The image signal is converted into a pulse-width modulated (PWM) laser beam by the control unit 300. A polygon scanner 310, serving as an exposing unit, scans the laser beam according to the image signal. Then, the laser beam is emitted onto photosensitive drums 200a to 200d, serving as electrostatic latent image bearing members of each of the image forming units Pa to Pd.

To be noted, the image forming units Pa, Pb, Pc, and Pd respectively form the toner images of corresponding colors: yellow (Y), magenta (M), cyan (C), and black (Bk). Since these image forming units Pa to Pd are substantially the same in configuration, hereinafter, the image forming unit Pa which forms the toner image of yellow (Y) will be described as an example, and the description of the other image forming units Pb to Pd will be omitted. In the image forming unit Pa, the toner image of yellow is formed on a surface of the photosensitive drum 200a based on the image signal.

A charge roller 201a provides preparation for the formation of an electrostatic latent image by charging the surface of the photosensitive drum 200a to a predetermined electric potential. With the laser beam from the polygon scanner 310, the electrostatic latent image is formed on the surface of the photosensitive drum 200a, which has been charged to the predetermined electric potential. A developing unit 202a forms the toner image by developing the electrostatic latent image on the photosensitive drum 200a. A primary transfer roller 203a discharges from the back of the intermediate transfer belt 204, and applies a primary transfer bias with opposite polarity to the toner. Thereby, the toner image on the photosensitive drum 200a is transferred onto the intermediate transfer belt 204. The surface of the photosensitive drum 200a is cleaned by the cleaner 207a after the transfer.

In addition, the toner image on the intermediate transfer belt 204 is conveyed to the subsequent image forming unit, and each color of the toner image, which is formed in sequence in the order of Y, M, C, and Bk at the respective image forming units Pa to Pd, is transferred onto a surface of the intermediate transfer belt 204. Thereby, the image of four colors is formed on the surface of the intermediate transfer belt 204. Then, the toner image having passed through the image forming unit Pd, positioned at the most downstream position in the rotational direction of the intermediate transfer belt 204, is conveyed to a secondary transfer potion T2 formed by a pair of secondary transfer rollers including a roller 205 and a roller 206. Then, by applying a secondary transfer electric field, opposite to the toner image on the intermediate transfer belt 204, at the secondary transfer portion T2, the toner image is secondarily transferred from the intermediate transfer belt 204 onto the recording material.

The recording material is stored in cassettes 9. The recording material fed from the cassette 9 is conveyed to a registration unit 208 composed of, for example, a pair of registration rollers, and waits at the registration unit 208. Thereafter, the timing of the registration unit 208 is controlled to align positions between the toner image on the intermediate transfer belt 204 and the recording material, and the registration unit 208 conveys the recording material to the secondary transfer portion T2.

The recording material on which the toner image has been transferred at the secondary transfer portion T2 is conveyed to a fixing unit 8, and, through the application of heat and pressure in the fixing unit 8, the toner image is fixed on the recording material. The recording material that has passed through the fixing unit 8 is discharged to a sheet discharge tray 7. To be noted, in a case of forming the image on both sides of the recording material, once the transfer and fixing of the toner image onto a first surface (front surface) of the recording material is completed, the front and back of the recording material are reversed by passing through a reverse conveyance portion 10. Then, the toner image is transferred and fixed onto a second surface (back surface) of the recording material, and the recording material is discharged onto the sheet discharge tray 7.

The control unit 300 controls the overall operation of the image forming apparatus 1. In addition, the control unit 300 can execute various settings and the like based on input from an operational unit 4 included in the image forming apparatus 1. This control unit 300 includes a central processing unit (CPU), a read only memory (ROM), and a random access memory (RAM). The control unit controls each unit while reading programs stored in the ROM corresponding to control procedures. In addition, the RAM stores working data and input data, and the CPU executes the control based on the programs described above and the like by referencing the data stored in the RAM.

### Fixing Unit

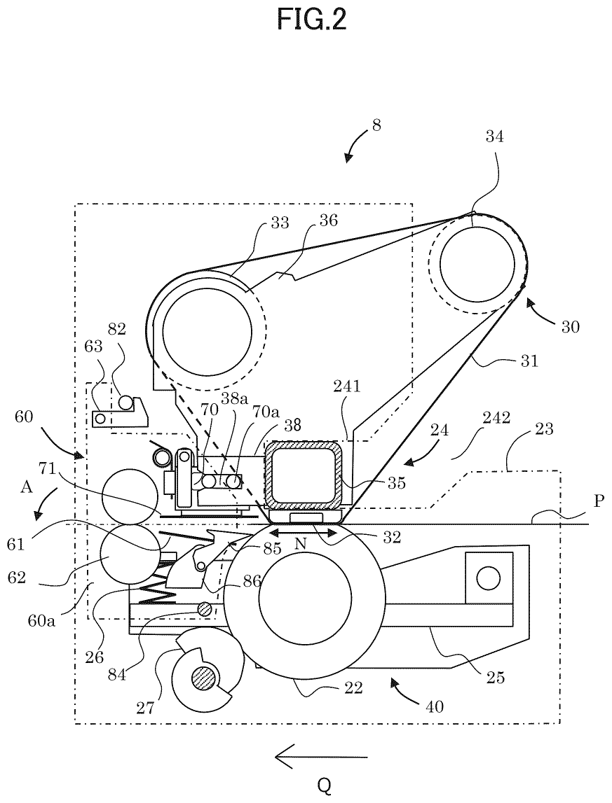

Next, using FIGS. 2 to 4, the fixing unit 8 of this embodiment will be described. As illustrated in FIG. 2, the fixing unit 8 is roughly divided into a heating unit 30, a pressing unit 40, and a sheet discharge unit 60.

The heating unit 30 includes an endless fixing belt 31, a heating roller 33, a steering roller 34, a stay 35, a pressing pad 32, and engagement members 38. Both ends of the stay 35, the heating roller 33, and the steering roller 34 are supported by a pair of heating unit side-plates 36. Then, in this embodiment, the pressing pad 32 and the engagement members 38 are secured to the stay 35. The pressing pad 32 is non-rotatably arranged on an inner peripheral side of the fixing belt 31, and can press or push the pressing roller 22 via the fixing belt 31.

The fixing belt 31, serving as a first rotary member, is a thin, endless belt member possessing thermal conductivity, heat resistance, and the like. In this embodiment, the fixing belt 31 is, for example, a three-layer structure including a base layer, an elastic layer formed on an outer circumference of the base layer, and a release layer formed on an outer circumference of the elastic layer. The base layer uses polyimide resin (PI) with a thickness of 80 micrometers (μm), the elastic layer uses silicone rubber with a thickness of 300 (μm), and the release layer uses tetrafluoroethylene-perfluoroalkoxyethylene copolymer resin (PFA), a type of fluoropolymer, with a thickness of 30 (μm). The fixing belt 31 is stretched by the stay 35 (pressing pad 32), the heating roller 33, and the steering roller 34.

The heating roller 33 is, for example, a pipe made of stainless steel with a thickness of 1 millimeter (mm), containing a halogen heater installed inside of the pipe, and can generate heat to a predetermined temperature using the halogen heater. The fixing belt 31 is heated by the heating roller 33. While illustration is omitted, a gear, not shown, is secured to a first end in a rotational axis direction (also referred to as a width direction W) of the heating roller 33, and the heating roller 33 is rotatably driven by being connected to a drive motor via the gear. The fixing belt 31 is rotated following the rotation of the heating roller 33. To be noted, the width direction W is a direction perpendicular to a conveyance direction of the recording material that passes through a fixing nip portion N.

The steering roller 34, serving as a stretching roller, has a substantially vertical pivot axis at a first end or near the center in the width direction W, and can adjust a position of the fixing belt 31 in a main scanning direction (width direction W) by generating a tension differential in the main scanning direction through pivoting with respect to the fixing belt 31. The steering roller 34 is formed by a hollow stainless steel (SUS) shaft with a diameter of, for example, 20 (mm). To increase grip force with respect to the fixing belt 31, rubber materials may be applied to the surface. To be noted, the steering roller 34 is urged by compression springs (not shown) supported by the heating unit side-plates 36, and also serves as a tension roller that can change a tensile force applied to the fixing belt 31.

The pressing pad 32 is pressed to the pressing roller 22 across the fixing belt 31. The fixing nip portion N is formed at a contact portion between the fixing belt 31 and the pressing roller 22. A lubricant sheet or lubricant (such as silicone oil) is interposed between the fixing belt 31 and the pressing pad 32, and, thereby, the fixing belt 31 is allowed to smoothly slide with respect to the pressing pad 32.

A material of the pressing pad 32 is liquid crystal polymer (LCP), and the pressure pad 32 is replaceably mounted on the stay 35. The stay 35 is a rigid member with high stiffness formed of stainless steel and the like, and is an elongated member extending in the width direction W to support the pressing pad 32 along the width direction W. The stay 35 is formed in a substantially rectangular-shaped cross-section with an opening at the bottom, and the pressing pad 32 is adhered to that opening. Both end portions of the stay 35 in the width direction W project further outside than the fixing belt 31, and both the end portions are supported by the pair of heating unit side-plates 36.

The pressing unit 40 includes the pressing roller 22, serving as a second rotary member, a pressing stay 25, at least one pressing spring 26, and at least one pressing cam 27. Both end portions of the pressing roller 22 in the width direction are supported by a pair of fixing frames 23. When the pressing stay 25 moves to a side of the heating unit 30 by a driving source, not shown, and the pressing cam 27, the pressing roller 22 presses the pressing pad 32 across the fixing belt 31 by an urging force of the pressing spring 26. Thereby, the fixing nip portion N is formed between the fixing belt 31 and the pressing roller 22. The pressing roller 22 is a roller with an elastic layer formed on an outer circumference of a shaft and a release layer formed on an outer circumference of the elastic layer. For example, the shaft uses stainless steel with a diameter of 72 (mm), the elastic layer uses conductive silicone rubber with a thickness of 8 (mm), and the release layer uses tetrafluoroethylene-perfluoroalkoxyethylene copolymer resin (PFA) with a thickness of 100 (μm). The shaft of the pressing roller 22 is supported by the fixing frames 23, and, while illustration is omitted, the pressing roller 22 is rotatably driven by being connected to a drive motor via a gear secured to a first end portion in the width direction W.

In this embodiment, by disposing the pressing unit 40 to be slidable in the width direction W with respect to the apparatus body 3 (refer to FIG. 1), a user can insert and remove the fixing unit 8 with respect to the apparatus body 3. Then, in the fixing unit 8, it is possible to mount and remove the heating unit 30 and the pressing unit 40. Therefore, by withdrawing the fixing unit 8 from the apparatus body 3 and detaching the heating unit 30 from the pressing unit 40, the user can perform the replacement of the fixing belt 31 and the pressing pad 32, or the like.

That is, during the image formation, the fixing belt 31 and the pressing pad 32 rub against each other while the heat and pressure are continuously applied. Therefore, even if the lubricant sheet or the lubricant is interposed between the fixing belt 31 and the pressing pad 32, the fixing belt 31 and the pressing pad 32 wear over time. Therefore, the fixing belt 31 and the pressing pad 32 need to be replaced as consumables in a case where the cumulative number of sheets of the recording material P on which the image has been formed reaches a predetermined count. To improve workability during the replacement of these fixing belt 31 and the pressing pad 32, as described above, it is configured such that the user can detach the heating unit 30 from the pressing unit 40 by withdrawing the fixing unit 8 from the apparatus body 3.

As illustrated in FIG. 2, guide portions 24 are formed in each of the fixing frames 23, serving as first frames arranged at both end portions in the width direction W. Through these guide portions 24, the heating unit 30 can be mounted or removed with respect to the pressing unit 40. The guide portion 24 includes a recess portion 241 into which the stay 35 is inserted when mounting the heating unit 30, and an opening portion 242 located upstream of the recess portion 241 in an insertion direction (arrow Q direction in FIG. 2). The opening portions 242 open to a side opposite to the pressing roller 22, and allow the stay 35 to pass through when mounting the heating unit 30. In this embodiment, by moving the stay 35, which has passed through the opening portions 242, along the recess portions 241 in accordance with the movement of the heating unit 30 by the user, the heating unit 30 is guided to a predetermined position in the pressing unit 40. At that time, by the opening portions 242 and the recess portions 241, it is possible to restrict the movement of the stay 35 in directions other than the insertion direction. In this embodiment, the insertion direction (arrow Q direction) of the stay 35 substantially aligns with the conveyance direction of the recording material P that is nipped and conveyed by the fixing nip portion N. Then, when the stay 35 abuts against the recess portions 241, the engagement members 38 (in particular, engagement grooves 38a) disposed on the stay 35 engage with a guide shaft 70a of a separation unit 70. Thereby, the heating unit 30 is positioned at an appropriate position with respect to the separation unit 70.

In the stay 35, the engagement members 38 are secured to a downstream side of the insertion direction (arrow Q direction) into the recess portions 241 of the stay 35. In addition, the engagement members 38 are secured to regions that are further outside than the end portions of the fixing belt 31. The engagement groove 38a is formed in the engagement member 38, and is formed on the downstream side of the engagement member 38 in the insertion direction of the stay 35. To be noted, the stay 35 is supported by the fixing frames 23 at positions further outside than positions at which the engagement members 38 are assembled.

The separation unit 70 includes a separation plate 71 and the guide shaft 70a, and is arranged further downstream than the fixing nip portion N in the conveyance direction of the recording material P. The separation plate 71, serving as a first separation member, can separate the recording material P, which has passed through the fixing nip N, from the fixing belt 31 without coming into contact with the fixing belt 31. The separation plate 71 is a metallic plate-like member, and, to prevent toner adhesion from the recording material P or disturbances in the toner image formed on the recording material P and the like due to rubbing against the passing recording material P, a fluorine-based tape (not shown) is applied to a surface side on which the recording material P passes.

The separation unit 70 is held by the sheet discharge unit 60, described below, such that the guide shaft 70a is positioned in the downstream side of the recess portions 241 in the insertion direction. The engagement grooves 38a, serving as engagement portions, are engaged with the guide shaft 70a, serving as a positioning portion, when mounting the heating unit 30. The user can position the heating unit 30 with respect to the separation unit 70 by engaging the engagement grooves 38a with the guide shaft 70a. Thereby, it is possible to position the fixing belt 31 and the separation plate 71 at appropriate positions at which the recording material P can be separated.

### Sheet Discharge Unit

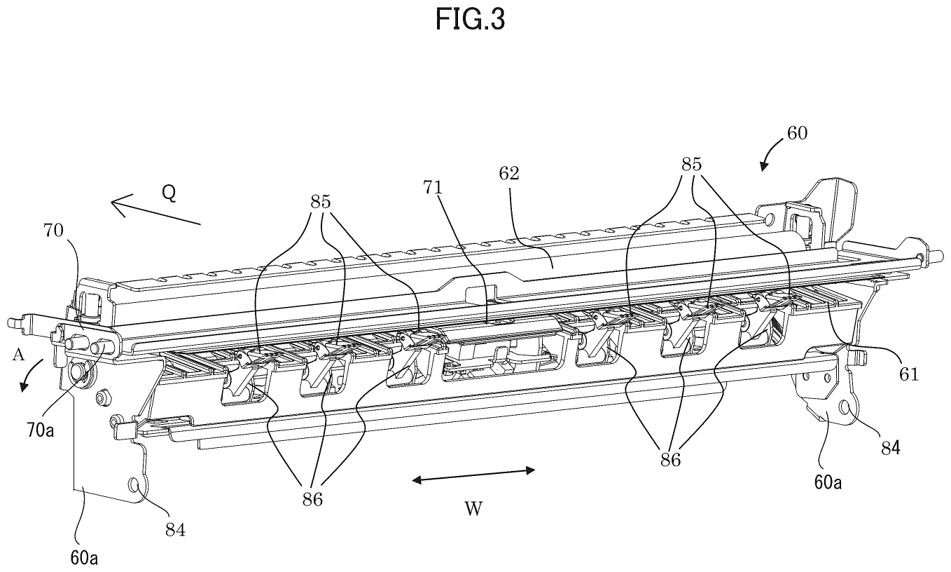

As illustrated in FIG. 2, the sheet discharge unit 60 for discharging the recording material P, which has passed through the fixing nip N, to the outside of the fixing unit 8 is arranged downstream in the conveyance direction of the fixing nip portion N. As illustrated in FIGS. 2 and 3, the sheet discharge unit 60 are equipped with the separation unit 70 including the separation plate 71, sheet discharge lower guides 61, a conveyance roller pair 62, and separation claws 85, and these separation unit 70, sheet discharge lower guides 61, conveyance roller pair 62, and separation claws 85 are integrally held by sheet discharge frames 60a, serving as second frames. The separation claws 85, serving as second separation members, are supported by separation claw supporting portions 86 of the discharge frames 60a in a pivotable manner with respect to the sheet discharge frames 60a. The separation claws 85 can separate the recording material P, which has passed through the fixing nip N, from the pressing roller 22 by coming into contact with the pressing roller 22. To enhance sliding properties with the recording material P that passes through, the separation claws 85 are formed of, for example, fluoro resin.

To be noted, it is preferable to arrange the separation claws 85 at a plurality of positions in the width direction W to suppress effects of eccentricities and dimensional variations in an outer diameter of the pressing roller 22 in the width direction W at contact positions at which the separation claws 85 make contact. In this embodiment, as an example, as illustrated in FIG. 3, six separation claws 85 are arranged at three positions on both the left and right sides with respect to the center in the width direction W.

The conveyance roller pair 62, serving as a conveyance unit, is arranged further downstream than the fixing nip portion N, the separation plate 71, and the separation claws 85 in the conveyance direction of the recording material P, and conveys the recording material P that has passed through the fixing nip portion N. The conveyance roller pair 62 is arranged, for example, at a position equal to or more than approximately 40 (mm) away from the fixing nip portion N.

In the sheet discharge unit 60 described above, the sheet discharge frames 60a are disposed on the fixing frames 23, and can pivot around a sheet discharge unit pivot shaft 84 as a center. That is, the sheet discharge frames 60a is configured to pivot between a first position and a second position. In this embodiment, the sheet discharge unit pivot shaft 84 of the sheet discharge frames 60a with respect to the fixing frames 23 is positioned downstream of the fixing nip portion N in the conveyance direction of the recording material P, and below the fixing nip portion N in the vertical direction. Therefore, the sheet discharge unit 60 pivots, and thus an upper side is opened and closed.

By pivoting the sheet discharge unit 60 in an arrow A direction in FIG. 2 from a closed state to a pivot angle of equal to or more than a predetermined angle (θ) with respect to a straight line passing through the fixing nip portion N, the fixing nip portion N is exposed. In a case where, for example, a so-called jam, in which the recording material P is stuck in the fixing nip portion N, has occurred, by opening the sheet discharge unit 60, the user can easily perform a removal operation of the recording material P jammed in the fixing nip portion N. To be noted, the sheet discharge unit 60 is secured in the closed state by engaging a locking member 63, which is pivotably disposed in the sheet discharge unit 60, with a locking shaft 82 disposed in the fixing frames 23.

As illustrated in FIG. 2, at positions (first positions) of the sheet discharge frames 60a when the sheet discharge unit 60 is in the closed state, the separation plate 71 is positioned at a first separation position at which the separation plate 71 can separate the recording material P from the fixing belt 31. In addition, the separation claws 85 are at a second separation position at which the separation claws 85 can separate the recording material P from the pressing roller 22, and, further, the conveyance roller pair 62 is positioned at a conveyance position at which the conveyance roller pair can convey the recording material P that has passed through the fixing nip portion N. In a state in which the sheet discharge frames 60a are at the first position, the separation claws 85 are positioned below the separation plate 71 in the vertical direction.

In this embodiment, when the sheet discharge unit 60 is closed, the guide shaft 70a of the separation unit 70 held by the sheet discharge unit 60 is engaged with the engagement grooves 38a of the engagement members 38 secured to the stay 35. Therefore, even if the sheet discharge unit 60 wobbles when pivoting, the sheet discharge unit 60 is positioned at an appropriate position with respect to the heating unit 30 and pressing unit 40. Since the sheet discharge unit 60 holds the separation plate 71 and the separation claws 85, the separation plate 71 is positioned at appropriate positions (first separation position) with respect to the fixing belt 31, and the separation claws 85 is positioned at appropriate positions (second separation position) with respect to the pressing roller 22.

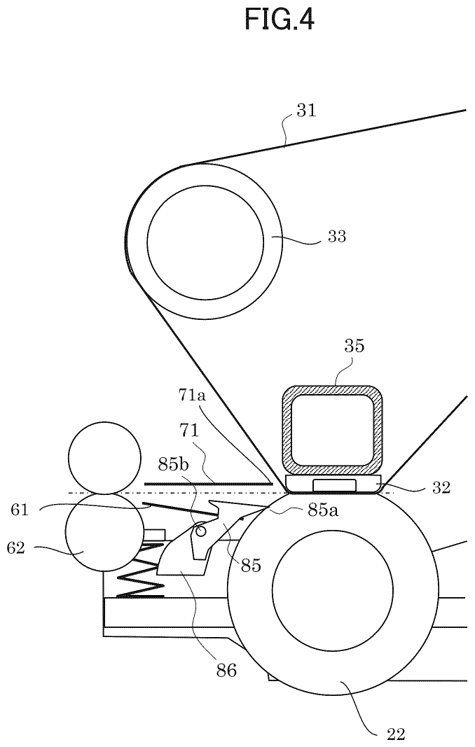

As illustrated in FIG. 4, when the sheet discharge unit 60 is in the closed state, the separation plate 71 is positioned at the first separation position as illustrated in FIG. 4. When the separation plate 71 is positioned at the first separation position, a tip portion 71a faces the fixing belt 31 with a predetermined gap therebetween. As described above, when closing the sheet discharge unit 60, the guide shaft 70a of the separation unit 70 is engaged with the engagement grooves 38a of the engagement members 38 disposed on the stay 35, so that the separation plate 71 is positioned at the first separation position.

On the other hand, when the sheet discharge unit 60 is in the closed state, the separation claws 85 are at the second separation position as illustrated in FIG. 4. When the separation claws 85 are at the second separation position, tip portions 85a come in contact with the pressing roller 22. That is, a distance between the separation plate 71 and the separation claws 85 in a case where the sheet discharge frames 60a is positioned at the second position is shorter than a distance between the separation plate 71 and the separation claws 85 in a case where the sheet discharge frames 60a is positioned at the first position. The separation claws 85 is configured not to come into contact with the separation plate 71 in a case where the sheet discharge frames 60a is positioned at the first position. Also, the separation claws 85 is configured to come into contact with the separation plate 71 in a case where the sheet discharge frames 60a is positioned at the second position. The separation claws 85 have the acute-angled tip portions 85a, and are pivotably supported by the separation claw supporting portions 86. A separation claw pivot shafts 86b are disposed in the separation claw supporting portions 86, and, when the separation claws 85 pivot around the separation claw pivot shafts 85b as centers with respect to the separation claw supporting portions 86 due to the own weight of the separation claws 85 (or spring, not shown), the tip portions 85a come into contact with the pressing roller 22. When closing the sheet discharge unit 60, until the guide shaft 70a of the separation unit 70 engages with the engagement grooves 38a of the engagement members 38 disposed on the stay 35, the separation claws 85 are pressed by the separation plate 71, and the separation claws 85 pivot toward the second separation position. Then, when the guide shaft 70a of the separation unit 70 engages with the engagement grooves 38a of the engagement members 38, the separation claws 85 move away from the separation plate 71 due to the own weight of the separation claws 85, and the tip portions 85a are positioned at the second separation position by coming into contact with the pressing roller 22.

### Separation Claw

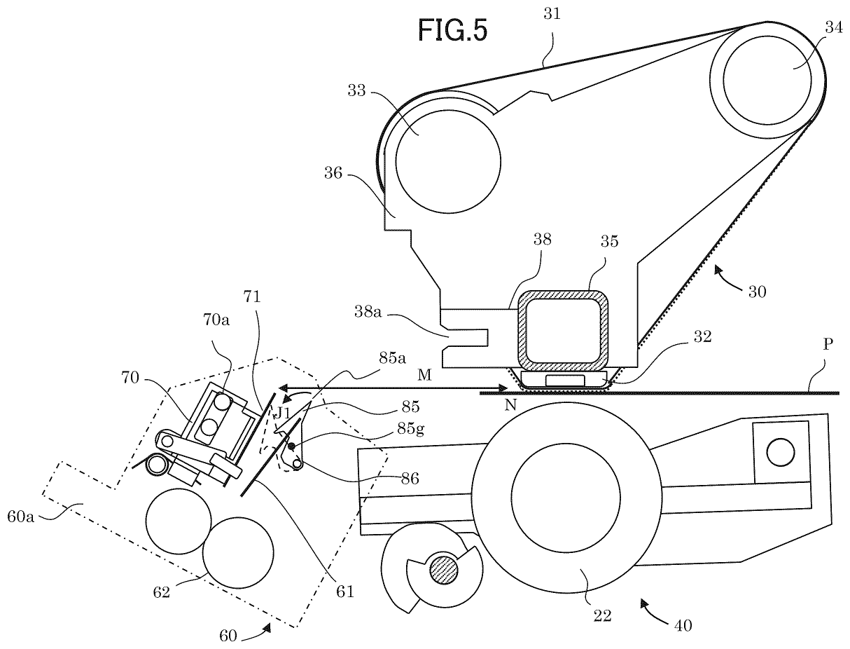

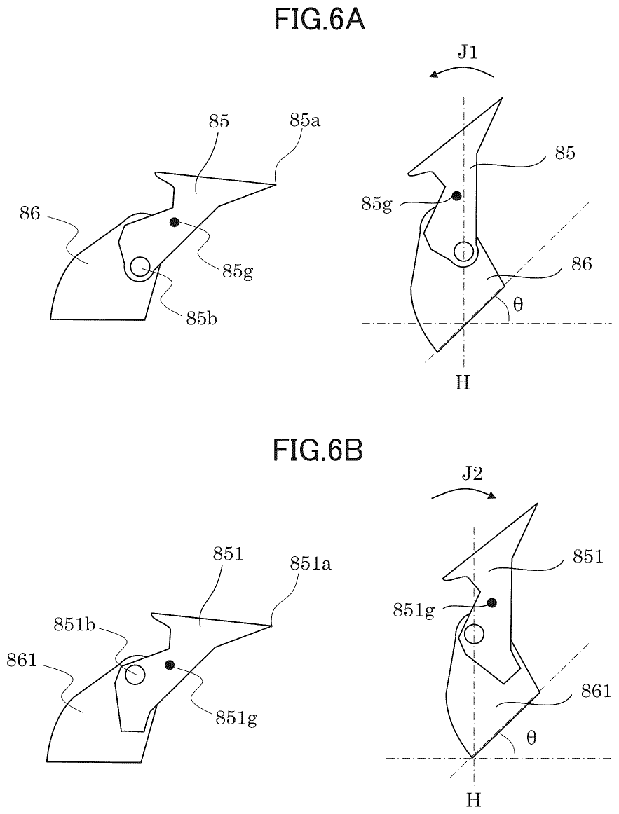

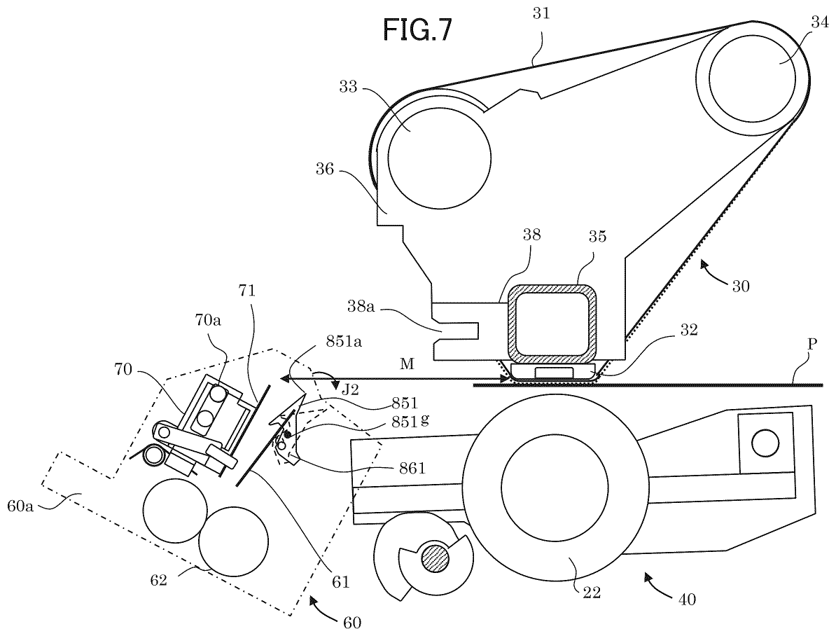

Next, using FIGS. 5 to 7, the separation claw 85 of this embodiment will be described while comparing it with a comparative example. FIG. 5 is a schematic diagram illustrating the separation claw of this embodiment in a state in which the sheet discharge unit is opened. FIG. 6A is a diagram illustrating the separation claw of this embodiment, and FIG. 6B is a diagram illustrating a separation claw of the comparative example. In FIGS. 6A and 6B, a state of the separation claw 85 (851) in a case where the sheet discharge unit 60 is closed is illustrated on the left, and a state of the separation claw 85 (851) in a case where the sheet discharge unit 60 is opened to the predetermined angle (Θ) is illustrated on the right. FIG. 7 is a schematic diagram illustrating the separation claw of the comparative example in the state in which the sheet discharge unit is opened. To be noted, FIGS. 5 and 7 illustrate a state in which the pressing roller 22 is moved to a side opposite to the heating unit 30 by the pressing stay 25 and the pressing cam 27 and is not pressing the pressing pad 32. In this state, the user can easily remove the recording material P jammed in the fixing nip portion N by pulling without applying significant force.

As illustrated in FIG. 5, at the position (second position) of the sheet discharge frame 60a when the sheet discharge unit 60 is in the opened state, the separation plate 71 is positioned at a first retracted position, at which the separation plate 71 is more retracted from the fixing belt 31 than the first separation position, at which the separation plate 71 can separate the recording material P from the fixing belt 31. In addition, the separation claw 85 is positioned at a second retracted position, at which the separation claw is more retracted from the pressing roller 22 than the second separation position, at which the separation claw 85 can separate the recording material P from the pressing roller 22, and, further, the conveyance roller pair 62 is positioned at a conveyance retracted position, at which the conveyance roller pair 62 is more retracted from the fixing nip portion N than the conveyance position, at which the conveyance roller pair 62 can convey the recording material P that has passed through the fixing nip portion N.

The separation claw 85 pivots with respect to the separation claw supporting portion 86 such that, in a case where the sheet discharge frame 60a is pivoted from the first position (refer to FIG. 2) to the second position (refer to FIG. 5), the tip portion 85a moves closer to the separation plate 71 than a state in which the tip portion 85a is positioned at the first position (refer to FIG. 2). Then, in a state in which the sheet discharge frame 60a is positioned at the second position (refer to FIG. 5), the tip portion 85a of the separation claw 85 is in contact with the separation plate 71. The tip portion 85a comes into contact with a surface of the separation plate 71 on the side on which the recording material P is separated. In this embodiment, the separation claw 85 is configured to move to the second separation position and the second retracted position due to its own weight depending on the pivot angle of the sheet discharge frame 60a. This is determined by the position of the center of gravity of the separation claw 85.

As illustrated in FIG. 6A, when the sheet discharge unit 60 is opened to the predetermined angle (Θ), the separation claw 85 of this embodiment is positioned such that the center of gravity 85g of the separation claw 85 is positioned to the left with respect to a vertical line H passing through the separation claw pivot shaft 85b. In this case, in a state in which the sheet discharge unit 60 has been further opened and is positioned at the second position (refer to FIG. 5), the center of gravity 85g of the separation claw 85 is located vertically upper than the pivot axis (separation claw pivot shaft 85b) with respect to the separation claw supporting portion 86 of the separation claw 85, and further to the side of the separation plate 71 (side of the first separation member) than the vertical line H passing through the pivot axis. That is, in a state in which the sheet discharge unit 60 is positioned at the second position, the center of gravity 85g of the separation claw 85 is located downstream of the vertical line H in the conveyance direction of the recording material P. Therefore, due to its own weight, the separation claw 85 attempts to tilt around the separation claw pivot shaft 85b as a center toward an arrow J1 direction in FIG. 6A opposite to the pressing roller 22. As illustrated by dotted lines in FIG. 5, when the separation claw 85 tilts toward the arrow J1 direction due to its own weight, the tip portion 85a of the separation claw 85 comes into contact with the separation plate 71 that has moved to the downstream side in the conveyance direction of the recording material P. In a state in which the separation claw 85 is in contact with the separation plate 71, the tip portion 85a of the separation claw 85 is hidden by the separation plate 71 between the separation plate 71 and the sheet discharge lower guide 61, and it is possible to reduce a possibility that hands of the user or the recording material P will touch the separation claw 85 during the processing of the jam.

On the other hand, as illustrated in FIG. 6B, even when the sheet discharge unit 60 has been opened to the predetermined angle (Θ), the separation claw 851 of the comparative example is positioned such that the center of gravity 851g of the separation claw 851 is positioned to the right with respect to the vertical line H passing through a separation claw pivot shaft 851b. In this case, in a state in which the sheet discharge unit 60 has been further opened and is positioned at a position illustrated in FIG. 7, the center of gravity 851g of the separation claw 851 is vertically upper than a pivot axis (separation claw pivot shaft 851b) with respect to a separation claw supporting portion 861 of the separation claw 851, but more to the side of the pressing roller 22 than the vertical line H passing through the pivot axis. Therefore, due to its own weight, the separation claw 851 attempts to tilt around the separation claw pivot shaft 851b as a center toward an arrow J2 direction in FIG. 6B opposite to the separation plate 71. As illustrated by dotted lines in FIG. 7, when the separation claw 851 tilts toward the arrow J2 direction due to its own weight, the tip portion 851a of the separation claw 851 protrudes into a jam processing space M which is formed on the side of the pressing roller 22 rather than the side of the sheet separation lower guide 61. In this state, there is a possibility that the hands of the user or the recording material P will touch the separation claw 851 during the processing of the jam. Therefore, the separation claw 851 of the comparative example is not preferred.

As described above, in this embodiment, in the case where the sheet discharge unit 60 is opened, the separation claw 85, which is pivotably supported with respect to the separation claw supporting portion 86, pivots to approach the separation plate 71, and the tip portion 85a of the separation claw 85 comes into contact with the separation plate 71. In the state in which the tip portion 85a of the separation claw 85 is in contact with the separation plate 71, the tip portion 85a of the separation claw 85 is hidden by the separation plate 71 and does not protrude into the jam processing space M. Therefore, it is possible to reduce the possibility that the hands of the user or the recording material P will touch the separation claw 85 during the processing of the jam.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-076022, filed May 8, 2024 which is hereby incorporated by reference herein in its entirety.

What is claimed is:

1. A fixing unit configured to fix a toner image on a recording material, the fixing unit comprising:
a first rotary member;
a second rotary member configured to come into contact with the first rotary member to form a nip portion with the first rotary member, the nip portion being configured to fix the toner image on the recording material by applying heat and pressure to the recording material, on which the toner image has been formed, while nipping and conveying the recording material;
a first frame configured to hold the first rotary member and the second rotary member;
a first separation member configured to separate the recording material from the first rotary member, the recording material having passed through the nip portion;
a second separation member configured to separate the recording material from the second rotary member, the recording material having passed through the nip portion;
a conveyance unit arranged downstream of the nip portion, the first separation member, and the second separation member in a conveyance direction of the recording material and configured to convey the recording material having passed through the nip portion;
a second frame holding the first separation member, the second separation member, and the conveyance unit, and configured to pivot with respect to the first frame; and
a supporting portion supporting the second separation member rotatably with respect to the second frame,
wherein the second frame is configured to pivot between a first position and a second position,
wherein the first position is a position at which the first separation member is positioned at a first separation position at which the first separation member separates the recording material from the first rotary member, the second separation member is positioned at a second separation position at which the second separation member separates the recording material from the second rotary member, and the conveyance unit is positioned at a conveyance position at which the conveyance unit conveys the recording material having passed through the nip portion,
wherein the second position is a position at which the first separation member is positioned at a first retracted position at which the first separation member is more retracted from the first rotary member than the first separation member at the first separation position is, the second separation member is positioned at a second retracted position at which the second separation member is more retracted from the second rotary member than the second separation member at the second separation position is, and the conveyance unit is positioned at a conveyance retracted position at which the conveyance unit is more retracted from the nip portion than the conveyance unit at the conveyance position is, and
wherein a distance between the first separation member and the second separation member in a case where the second frame is positioned at the second position is shorter than a distance between the first separation member and the second separation member in a case where the second frame is positioned at the first position.

2. The fixing unit according to claim 1, wherein, in the case where the second frame is positioned at the first position, the second separation member is positioned below the first separation member in a vertical direction.

3. The fixing unit according to claim 2, wherein a pivot shaft of the second frame with respect to the first frame is disposed downstream of the nip portion in the conveyance direction and below the nip portion in the vertical direction.

4. The fixing unit according to claim 3, wherein, in the case where the second frame is positioned at the second position, a center of gravity of the second separation member is disposed above a pivot axis of the second separation member with respect to the supporting portion in the vertical direction and downstream of a vertical line passing through the pivot axis in the conveyance direction.

5. The fixing unit according to claim 1,
wherein the first separation member is a plate-like member arranged to align with the conveyance direction in the case where the second frame is positioned at the first position, and
wherein a tip portion of the first separation member is configured to face the first rotary member with a predetermined gap therebetween in a state where the first separation member is positioned at the first separation position.

6. The fixing unit according to claim 1, further comprising:
an engagement member in which an engagement portion is formed; and
a positioning portion,
wherein the first rotary member is configured to be detachably mounted with respect to the first frame, and
wherein, when the first rotary member is mounted to the first frame in a state where the second frame is positioned at the first position, the positioning portion is configured to engage with the engagement portion to position the first separation member with respect to the first rotary member and to position the second separation member with respect to the second rotary member.

7. The fixing unit according to claim 6, further comprising:
a plurality of rollers;
a pad; and
a stay,
wherein the first rotary member is an endless belt,
wherein the plurality of rollers are configured to stretch the belt,
wherein the pad is arranged on an inner peripheral side of the belt and configured to push the second rotary member through the belt,
wherein the stay is configured to support the pad,
wherein the belt is held by the first frame through the rollers, the pad, and the stay, and
wherein the engagement member is secured to the stay.

8. The fixing unit according to claim 7,
wherein the first frame includes a recess portion into which the stay is configured to be inserted in a state where the first rotary member is mounted to the first frame, and
wherein the positioning portion is disposed in a downstream side of the recess portion in an insertion direction of the stay in the state where the second frame is positioned at the first position.

9. The fixing unit according to claim 8, wherein the engagement portion is formed on a downstream side of the engagement member in the insertion direction.

10. The fixing unit according to claim 1,
wherein the second separation member is configured not to come into contact with the first separation member in the case where the second frame is positioned at the first position, and
wherein the second separation member is configured to come into contact with the first separation member in the case where the second frame is positioned at the second position.

11. A fixing unit configured to fix a toner image on a recording material, the fixing unit comprising:
a first rotary member;
a second rotary member configured to come into contact with the first rotary member to form a nip portion with the first rotary member, the nip portion being configured to fix the toner image on the recording material by applying heat and pressure to the recording material, on which the toner image has been formed, while nipping and conveying the recording material;
a first frame configured to hold the first rotary member and the second rotary member;
a first separation member configured to separate the recording material from the first rotary member, the recording material having passed through the nip portion;
a second separation member configured to separate the recording material from the second rotary member, the recording material having passed through the nip portion;
a conveyance unit arranged downstream of the nip portion, the first separation member, and the second separation member in a conveyance direction of the recording material and configured to convey the recording material having passed through the nip portion;
a second frame holding the first separation member, the second separation member, and the conveyance unit, and configured to pivot with respect to the first frame; and
a supporting portion supporting the second separation member rotatably with respect to the second frame,
wherein the second frame is configured to pivot between a first position and a second position,
wherein the first position is a position at which the first separation member is positioned at a first separation position at which the first separation member separates the recording material from the first rotary member, the second separation member is positioned at a second separation position at which the second separation member separates the recording material from the second rotary member, and the conveyance unit is positioned at a conveyance position at which the conveyance unit conveys the recording material having passed through the nip portion,
wherein the second position is a position at which the first separation member is positioned at a first retracted position at which the first separation member is more retracted from the first rotary member than the first separation member at the first separation position is, the second separation member is positioned at a second retracted position at which the second separation member is more retracted from the second rotary member than the second separation member at the second separation position is, and the conveyance unit is positioned at a conveyance retracted position at which the conveyance unit is more retracted from the nip portion than the conveyance unit at the conveyance position is,
wherein the second separation member is configured not to come into contact with the first separation member in a case where the second frame is positioned at the first position, and
wherein the second separation member is configured to come into contact with the first separation member in a case where the second frame is positioned at the second position.
